(19) United States
(12) Patent Application Publication
(10) Pub. No.: US 2009/0249924 A1
(43) Pub. Date: Oct. 8, 2009

(54) Torque-Indicating Extensive Apparatus

(76) Inventor: Heiao-Feng Lin, Taiping City (TW)

Correspondence Address: Dr. BANGER SHIA;Int''l Patent Office of Bang Shia, 102 Lindencrest Ct, Sugar Land, TX, 77479-5201, US

(21) Appl. No.: 12/409,452

(22) Filed: Mar. 23, 2009

(30) Foreign Application Priority Data
Apr. 3, 2008 (TW) 097112258

(51) Int. Cl. B25B 23/144

(52) U.S. Cl. 81/479

(57) ABSTRACT

A tool kit includes a handle, many bits and a torque-indicating extensive apparatus provided between the handle and a selected one of the bits. A torque-indicating extensive apparatus includes an extensive rod, at least one sensor and a display unit. The extensive rod includes a first bit-engaging section, a second bit-engaging section and a connective section formed between the first and second bit-engaging sections. The sensor is attached to extensive rod and used to sense a value of torque in the extensive rod and send a signal. The display unit is electrically connected to the sensor and used to show a reading of torque based on the signal.

### BACKGROUND OF INVENTION

1. Field of Invention

The present invention relates to a torque tool and, more particularly, to a torque-indicating extensive apparatus for a torque tool.

2. Related Prior Art

Torque tools such as screwdrivers, wrenches and Allen keys are used to tighten or slacken fasteners such as screws or nuts. For example, a conventional wrench includes a handle formed with one or two open or boxed ends. Therefore, the conventional wrench can be used to tighten or slacken two sizes of fasteners. Many conventional wrenches are needed to drive many sizes of fasteners, and this is an inconvenient and expensive practice.

There has been devised a tool kit including a handle and many bits. A selected one of the bits is engaged with the handle to drive a size of fasteners. It is however difficult to use this tool kit to drive a fastener located in a narrow and deep space.

There has been a tool kit including a handle, many bits and an extensive rod. An end of the extensive rod is engaged with a selected one of the bits, and another end of the extensive rod is engaged with the handle. Thus, this tool kit can be used to drive a fastener located in a narrow and deep space.

On the other hand, it is important to exert proper torque on a fastener, not too large or too small, because the fastener may be used to join together delicate parts. A torque gauge is used to indicate a value of torque exerted on a fastener. To this end, there is devised a tool kit including a tool, many bits, an extensive rod and a torque gauge. The torque gauge is secured to the handle. However, the provision of the torque gauge on the handle changes the profile of the handle and might interfere with smooth operation of the tool kit. Furthermore, a reading of torque shown on the torque gauge might not be exactly the value of torque in the fastener when the extensive rod is used between the handle and the bit. Moreover, a screwdriver-based tool kit and a wrench-based tool kit require different handles. Therefore, two different tool kits require two torque gauges, and this is an expensive practice.

Therefore, the present invention is intended to obviate or at least alleviate the problems encountered in prior art.

### SUMMARY OF INVENTION

It is the primary objective of the present invention to provide a torque tool with a torque-indicating extensive apparatus.

To achieve the foregoing objective, the torque-indicating extensive apparatus includes an extensive rod, at least one sensor and a display unit. The extensive rod includes a first bit-engaging section, a second bit-engaging section and a connective section formed between the first and second bit-engaging sections. The sensor is attached to extensive rod and used to sense a value of torque in the extensive rod and send a signal. The display unit is electrically connected to the sensor and used to show a reading of torque based on the signal.

Other objectives, advantages and features of the present invention will be apparent from the following description referring to the drawings.

### BRIEF DESCRIPTION OF DRAWINGS

The present invention will be described via detailed illustration of two embodiments referring to the drawings.

FIG. 1 is a perspective view of a torque-indicating extensive apparatus according to the first embodiment of the present invention.

FIG. 2 is a top view of the torque-indicating extensive apparatus shown in FIG. 1.

FIG. 3 is an exploded view of the torque-indicating extensive apparatus shown in FIG. 1.

FIG. 4 is a cross-sectional view of the torque-indicating extensive apparatus shown in FIG. 1.

FIG. 5 is an exploded view of a torque tool and the torque-indicating extensive apparatus shown in FIG. 1.

FIG. 6 is a perspective view of a torque-indicating extensive apparatus according to the second embodiment of the present invention.

### DETAILED DESCRIPTION OF EMBODIMENTS

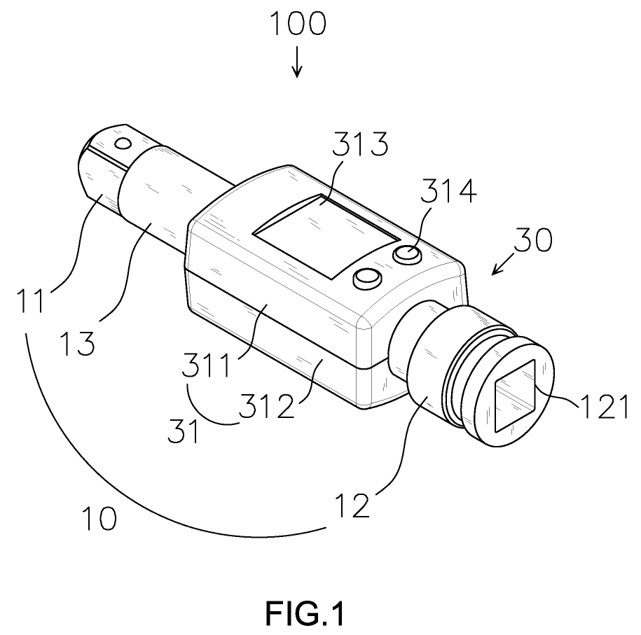

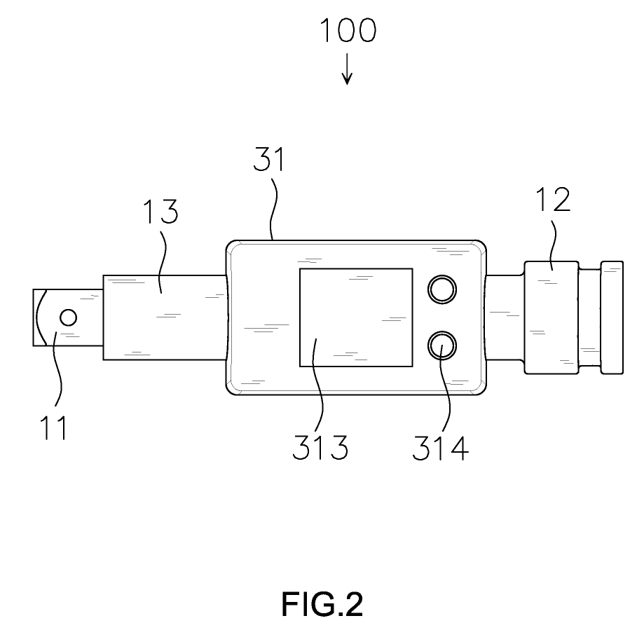

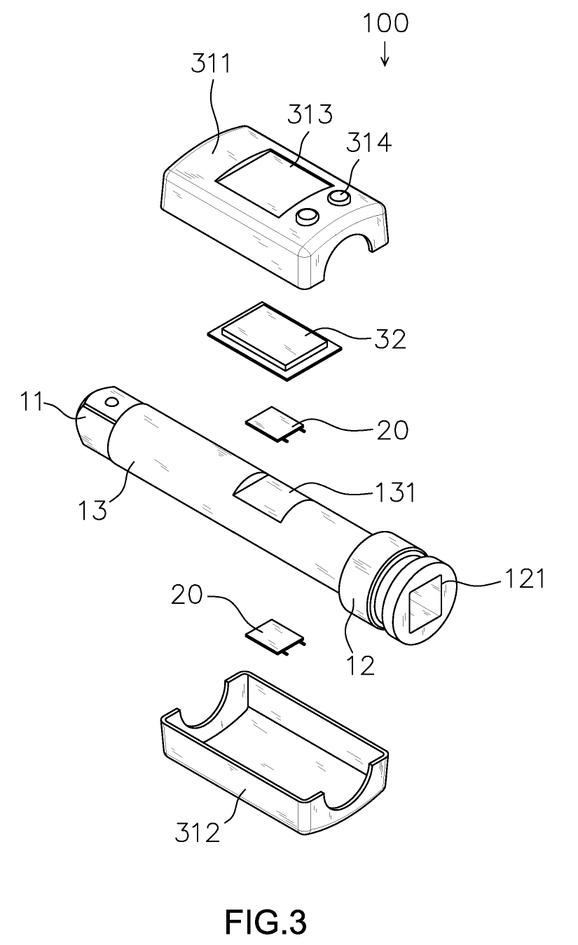

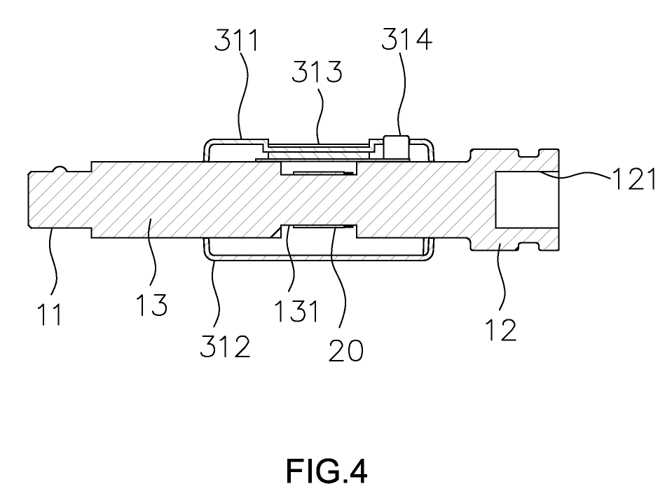

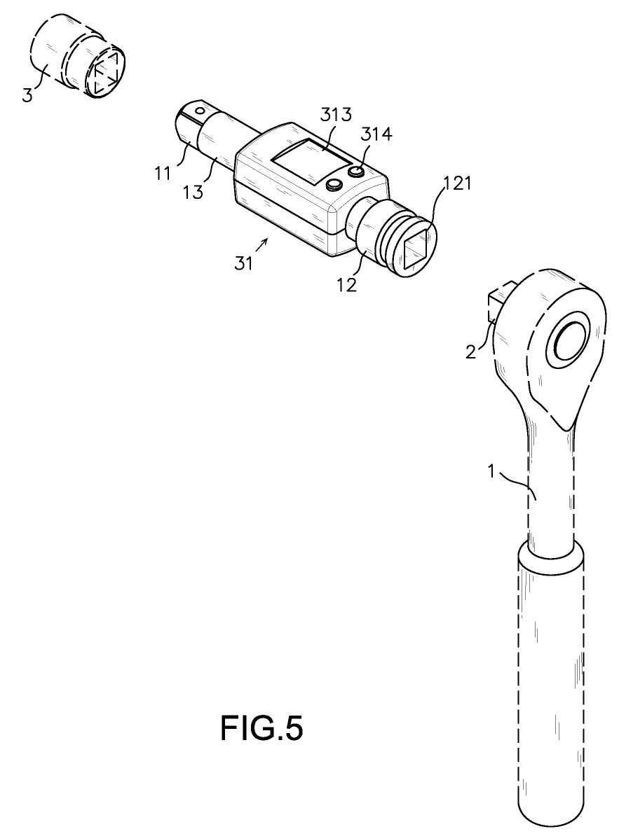

Referring to FIGS. 1 to 4, a torque-indicating extensive apparatus 100 includes an extensive rod 10, two sensors 20 and a display unit 30 according to a first embodiment of the present invention. Referring to FIG. 5, the torque-indicating extensive apparatus 100 is provided between a handle 1 and a socket 3 for example.

The extensive rod 10 includes a first bit-engaging section 11, a second bit-engaging connective section 12 and a connective section 13 formed between the bit-engaging sections 11 and 12. The first bit-engaging section 11 includes a square profile for insertion into a square cavity 121 defined in the socket 3. However, in another embodiment, the first bit-engaging section 11 can include any other proper polygonal profile such as a hexagonal profile. The second bit-engaging section 12 includes a square cavity 121 for receiving a squire insert 2 of the handle 1. However, in another embodiment, the second bit-engaging section 12 can include any other proper polygonal profile such as a hexagonal cavity. The connective section 13 includes a circular profile with two opposite plain faces 131. However, in another embodiment, the connective section 13 can include a square or hexagonal profile for example.

The sensors 20 are preferably strain gauges. Each of the sensors 20 is securely located on a related one of the plain faces 131.

The display unit 30 includes a shell 31 and a circuit board 32. The shell 31 includes an upper half 311 and a lower half 312 attached to the upper half 311. The extensive rod 10 is provided between the halves 311 and 312 before the halves 311 and 312 are joined together. A digital display 313 is provided on the upper half 311. Buttons or keys 314 are provided on the upper half 311. The digital display 313 is electrically connected to the sensors 20 on one hand and to the circuit board 32 and buttons 314 on the other hand.

In operation, the torque-indicating extensive apparatus 100 is provided between the socket 3 and the handle 1. The sensors 20 detect torque in the extensive rod 10, and send signals to the circuit board 32. Then, the circuit board 32 provides a reading of torque based on the signals that it receives from the sensors 20. Finally, the circuit board 32 instructs the digital display 313 to show the reading of torque.

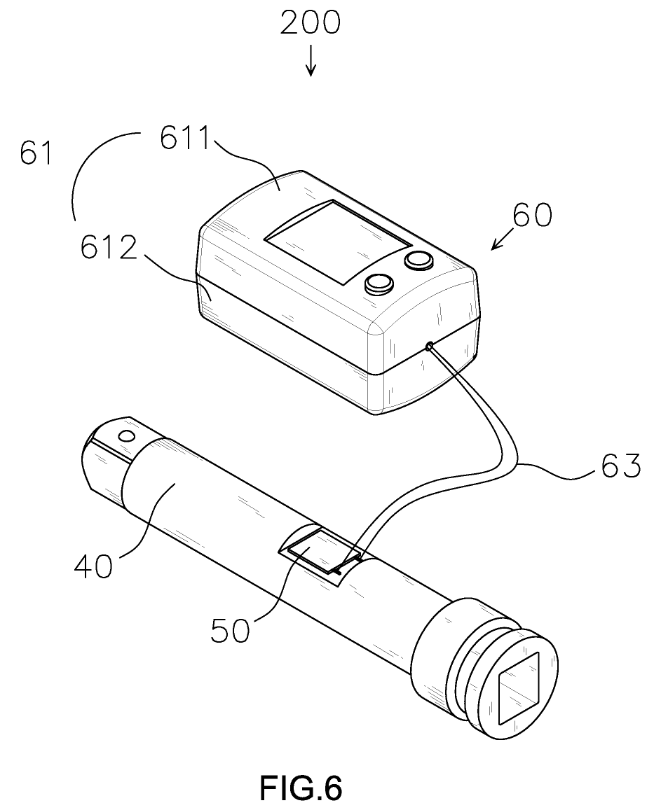

Referring to FIG. 6, a torque-indicating extensive apparatus 200 includes an extensive rod 40, two sensors 50 and a display unit 60 according to a second embodiment of the present invention. The extensive rod 40 is identical to the extensive rod 10 and will not be described in detail. The sensors 50 are identical to the sensors 20 and will not be described in detail. The display unit 60 is like the display unit 30 except two things. Firstly, there is used a shell 61 instead of the shell 31. The shell 61 includes two halves 611 and 612 that are not provided on opposite sides of the extensive rod 40. Secondly, there are used two wires 63 for connecting the sensors 50 to a circuit board of the display unit 60.

The torque-indicating extensive apparatus of the present invention exhibits at least three advantages over the prior art. Firstly, it does not change the profile of the handle, and therefore does not interfere with smooth operation of the tool kit. Secondly, it shows a reading of torque that exactly represents the value of torque in a fastener. Thirdly, it can be used together with different handles, and renders it inexpensive to enable different tool kits to indicate readings of torque.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A torque-indicating extensive apparatus comprising:
an extensive rod comprising a first bit-engaging section, a second bit-engaging section and a connective section formed between the first and second bit-engaging sections;
at least one sensor attached to extensive rod and used to sense a value of torque in the extensive rod and send a signal; and
a display unit electrically connected to the sensor and used to show a reading of torque based on the signal.

2. The torque-indicating extensive apparatus according to claim 1, wherein the connective section of the extensive rod comprises at least one plain face for supporting the sensor.

3. The torque-indicating extensive apparatus according to claim 1, wherein the sensor is a strain gauge.

4. The torque-indicating extensive apparatus according to claim 1, wherein the connective section of the extensive rod is inserted through the display unit.

5. The torque-indicating extensive apparatus according to claim 1, comprising wires for connecting the sensor to the display unit.

6. The torque-indicating extensive apparatus according to claim 1, wherein the display unit comprises:
a shell;
a digital display provided on the shell; and
a circuit board disposed in the shell and electrically connected to the digital display on one hand and to the sensor on the other hand.

7. The torque-indicating extensive apparatus according to claim 6, wherein the display unit comprises at least one button provided on the shell and electrically connected to the circuit board.

8. The torque-indicating extensive apparatus according to claim 1, wherein the first bit-engaging section of the extensive rod comprises a polygonal profile while the second bit-engaging section of the extensive rod comprises a polygonal cavity.

9. The torque-indicating extensive apparatus according to claim 8, wherein the polygonal profile of the first bit-engaging section of the extensive rod is square while the cavity of the second bit-engaging section of the extensive rod is a square cavity.

10. The torque-indicating extensive apparatus according to claim 8, wherein the polygonal profile of the first bit-engaging section of the extensive rod is hexagonal while the cavity of the second bit-engaging section of the extensive rod is a hexagonal cavity.
